(19) United States
(12) Patent Application Publication
(10) Pub. No.: US 2025/0296078 A1
(43) Pub. Date: Sep. 25, 2025

(54) TREATING WASTE STREAMS WITH ADVANCED SEPARATION TECHNOLOGIES

(71) Applicant: NEW MATTOCK RESOURCES, INC., Atlanta, GA (US)

(72) Inventor: Zachary Scott Campbell, Atlanta, GA (US)

(73) Assignee: NEW MATTOCK RESOURCES, INC., Atlanta, GA (US)

(21) Appl. No.: 19/086,560

(22) Filed: Mar. 21, 2025

Related U.S. Application Data
(60) Provisional application No. 63/568,932, filed on Mar. 22, 2024.

(51) Int. Cl. B01J 47/024; B01D 15/22; B01D 15/36; B01J 20/26; B01J 20/30; B01J 47/12

(52) U.S. Cl. CPC B01J 47/024; B01D 15/22; B01D 15/361; B01J 20/265; B01J 20/3078; B01J 20/3085; B01J 47/12

(57) ABSTRACT

Disclosed are materials and methods for the extraction and purification of target analytes using chromatography techniques. The materials may comprise woven or non-woven polymer mats functionalized with a selected surface chemistry and formed into cartridges for use in chromatography techniques.

### CROSS REFERENCE TO RELATED APPLICATIONS

This application claims the benefit of an priority to U.S. Provisional Application No. 63/568,932, filed on Mar. 22, 2024, which is hereby incorporated by reference in its entirety.

### FIELD OF THE INVENTION

The present disclosure relates generally to materials and methods for the extraction and purification of target analytes from a mixture. In particular, the present disclosure relates to modified woven or non-woven polymer mats having a surface chemistry to improve the binding capacity of the target analytes. Described also are methods of making the materials for use in chromatography techniques.

### BACKGROUND OF THE INVENTION

Ion exchange chromatography is a technique capable of separating compounds based on their net charge. The media used in the chromatography column contains either positively or negatively charged functional groups bound to a solid surface support yielding either a cation or anion exchanger. The compounds passed through the column are retained or absorbed by an ion having the opposite charge, while compounds having a neutral or similar charge to the charge on the solid support pass through the column and are eluted.

Existing ion exchange chromatography columns commonly employ resin beads as the solid support. These ion exchange beads are packed into fixed bed reactors, fluidized bed reactors, and “resin-in-pulp” agitated vessels, among other vessels, depending on the target ion to be extracted and the solids content of the feed containing the target solute. The packing density, diameter of the beads, and reliance on diffusion-based mass transfer leads to reduced column productivities due to slower mass transport and overall flow rates. The reliance on diffusive mass transport of target ions to the functional groups inside the resin beads significantly reduces the accessible flow rates which may be utilized for separations using traditional bead-based systems, as sufficiently long residence times must be utilized to allow the target solutes to diffuse into the bead-based resin systems for efficient separation.

Because of the difficulty confining ion exchange selectivity to a specific target solute when many solutes of similar electrostatic properties are present in the feed, current ion exchange processes can require capital and time-intensive purification/impurity-removal steps prior to final processing to obtain technical or commodities-exchange grade purity and form. In addition, attrition of ion exchange beads due to swelling and osmotic shock generally ranges from 1-3% per year. Despite the relatively slow mass transfer and requirement in some process flows to incorporate an expensive purification step, ion exchange has found extraction applications in precious metals (typically from sodium cyanide leachate feeds), base metals (often from sulfuric acid-based leachates), lithium extraction (from brines highly concentrated in chloride and/or sulfate salts), pharmaceuticals, nutraceuticals, petrochemicals, protein separations, the food industry, and municipal and industrial wastewater treatment, among many others.

### SUMMARY OF THE INVENTION

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

In one aspect described herein are novel porous materials for chromatography separation comprising: a woven or non-woven polymer, wherein the woven or non-woven polymer has a modified surface chemistry to produce a modified porous material, wherein the modified surface chemistry increases a binding capacity or the target analyte. In some embodiments, the woven or non-woven polymer comprises polysulfones, polyamides, polyimides, polyamideimides, polyaramids, polyesters, polycarbonates, polyethylene, polypropylene, or any combination thereof. In some embodiments, the modified porous material is punched into a disk, or wherein the modified porous material mat is wound around an inert core to produce a layered structure, wherein the layered structure has from 1 to 1000 layers. The disk may have a diameter of from 0.5 inches to about 300 inches. In some embodiments, the porous material may have a modified surface chemistry. For example, the surface chemistry includes at least one functional group, wherein the functional group is carboxylic, aminophosphonic, aminophosphinic, phosphonic, phosphinic, iminodiacetic, sulfonic, bis-picolylamine, quaternary ammonium, phosphorylcholines, sulfobetaines, carboxybetaines, linear polypropyleneimine, branched polypropyleneimine, linear polyethyleneimine, branched polyethyleneimine, zwitterionic, or amphoteric functional groups or any combination thereof. The modified surface chemistry may alter the surface binding of the porous material, wherein the surface chemistry modifies the porous material to have a binding capacity of from 0.01 to 20 mg/mL.

Another aspect described herein are novel methods for modifying a porous material including: producing a disk or a spiral configuration including a woven or nonwoven polymer; and; contacting the disk or spiral configuration with a solution or series of solutions, wherein the solution or series of solutions functionalizes the disk or spiral configuration with a surface chemistry for selected extraction. In some embodiments, the woven or non-woven polymer comprises polysulfones, polyamides, polyimides, polyesters, polycarbonates, polyethylene, polypropylene, or any combination thereof. The woven or non-woven polymer may be punched into mats having a diameter of from 0.5 inches to about 300 inches or wherein the spiral configuration comprises: an inert central core; and the woven or non-woven polymer layered around the inert central core includes from 1 to 1000 layers. Furthermore, the method may include modifying the surface chemistry of the polymer material. The surface chemistry includes at least one functional group, wherein the functional group is carboxylic, aminophosphonic, aminophosphinic, phosphonic, phosphinic, iminodiacetic, sulfonic, bis-picolylamine, quaternary ammonium, phosphorylcholines, sulfobetaines, carboxybetaines, linear polypropyleneimine, branched polypropyleneimine, linear polyethyleneimine, branched polyethyleneimine, zwitterionic, or amphoteric functional groups or any combination thereof.

In yet another aspect described herein is a method of producing a cartridge comprising: providing a mat including a woven or non-woven polymer; stacking at least two disks punched from the mat or winding the mat around an inert core to produce a spiral configuration; optionally pressing the stack of at least two disks together; and applying an epoxy to an outer diameter of the stacked disks or an outer layer of the spiral configuration, wherein the epoxy cures to form a waterproof seal around the outer diameter of the stacked disks or forms a water proof seal around the outermost layer of the spiral configuration. The method may further include stacking from at least 2 to 1000 mats together or wherein the winding includes producing a spiral configuration including from 1 to 1000 layers. In some embodiments, the stack of at least two mats are pressed together under pressure, wherein the pressure used for forming the stack is from 0 to 60 pounds per square inch (PSI). The stack may be subsequently encased in an epoxy to provide a sealant around the outer edges of the cartridge. For example, the epoxy used comprises Novolac 630, Novolac 633, vinyl ester 663 epoxies, or any combination thereof. In some embodiments, the woven or non-woven polymer comprises polysulfones, polyamides, polyimides, polyamideimides, polyaramids, polyesters, polycarbonates, polyethylene, polypropylene, or any combination thereof. In some embodiments, the at least two mats have a diameter of from 0.5 inches to about 300 inches or wherein the woven or non-woven polymer layered around the inert central core has from 1 to 1000 layers in the spiral configuration. In some embodiments, the method of may further include: a treatment step wherein the cartridge is treated with a solution to functionalize the woven or non-woven polymer, wherein the treatment comprising: heating the solution to a temperature appropriate for the treatment of the cartridge; pouring or flowing the heated solution into the cartridge to functionalize the woven or non-woven polymer for a selected surface chemistry. In some embodiments, the surface chemistry includes at least one functional group, wherein the functional group is carboxylic, aminophosphonic, aminophosphinic, phosphonic, phosphinic, iminodiacetic, sulfonic, bis-picolylamine, quaternary ammonium, phosphorylcholines, sulfobetaines, carboxybetaines, linear polypropyleneimine, branched polypropyleneimine, linear polyethyleneimine, branched polyethyleneimine, zwitterionic, or amphoteric functional groups or any combination thereof.

In yet another aspect, described herein is a method of generating a column of a modified porous substrate material comprising: equilibrating a chromatographic column and at least one cartridge to a temperature; installing the cartridge of any of the embodiments described herein into the chromatographic column; filling the chromatographic column with a fluid, a priming solution, or a buffer; and enclosing the chromatographic column, wherein the chromatographic column has a flow rate of from 0.01 m³/hour to 1000 m³/hour. In some embodiments, the buffer may citric acid, lactic acid, acetic acid, 2-(N-Morpholino) ethanesulfonic acid (MES), N-(2-Acetamido)-2-iminodiacetic acid (ADA), 3-(N-Morpholino) propanesulfonic acid (MOPS), N-(2-Hydroxyethyl) piperazine-N′-(2-ethanesulfonic acid) (HEPES), phosphate, bicine, N-Methylpiperazine, Piperazine, L-Histadine, bis-Tris, bis-tris propane, triethanolamine, Tris, N-Methyldiethanolamine, Diethanolamine, 1,3-Diaminopropane, Ethanolamine, Piperazine, and piperdine, imidazole, N-ethylmorpholine, triethanolamine, 2-amino-2-methyl-1,3-propanediol, 2-amino-2-methyl-1-propanol, or any combination thereof. In some embodiments, the chromatographic column may have a flow rate of from 0.01 m³/hour to 1000 m³/hour.

### BRIEF DESCRIPTION OF THE DRAWINGS

A further understanding of the nature and advantages of the present disclosure may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1A is a general schematic of ions moving through a chromatography column in accordance with embodiments of the present disclosure.

FIG. 1B is a schematic of an example commercial chromatography column demonstrating the flow of ions through a column before extraction in accordance with embodiments of the present disclosure.

FIG. 2A is a general schematic of a disk produced from a woven or non-woven polymer mat, in accordance with some embodiments of the present disclosure.

FIG. 2B, is a general schematic of a cartridge produced from stacking more than one disk to form the cartridge, in accordance with some embodiments of the present disclosure.

FIG. 2C is a general schematic of a column produced from combining more than one cartridge of FIG. 2B in accordance with embodiments of the present disclosure.

FIG. 3A is a general schematic of columns loaded with more than one cartridge having the same surface chemistry in accordance with embodiments of the present disclosure.

FIG. 3B is a general schematic of columns loaded with more than one cartridge having different surface chemistries in accordance with embodiments of the present disclosure.

FIG. 4A is a general schematic of a front view of a spiral configuration produced from a woven or non-woven polymer mat, in accordance with some embodiments of the present disclosure.

FIG. 4B, is a general schematic of a side view a cartridge produced having the spiral configuration, in accordance with some embodiments of the present disclosure.

FIG. 4C is a general schematic of a column produced from combining more than one cartridge of FIG. 2B in accordance with embodiments of the present disclosure.

FIG. 5 is a desorption chromatogram of the bind and elute experiments in accordance with embodiments of the present disclosure.

### DETAILED DESCRIPTION

### Introduction

Existing ion exchange technology has been around for decades, using divinylbenzene-crosslinked polystyrene resin as the backbone of the stationary phase. The resin is subsequently functionalized with any number of different surface chemistries to increase the polymers applicability to certain solutes, as measured by functional group density (binding capacity). These resins are extruded into sub-millimeter bead form allowing for a high density of surface area to allow for binding either the target or impurity.

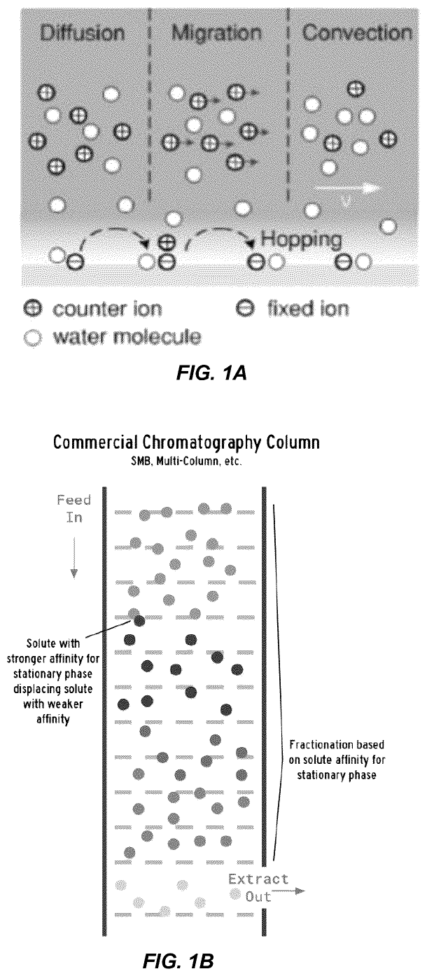

Initially, a column may be packed with an ion exchange stationary phase. Once packed the column may be prepared for the introduction of the feed solution. The feed containing the target solute is flowed through the selected stationary phase, solutes in the feed react with the functional groups of the beads, displacing less electrostatically active solutes bound to the functional groups though ionic or coordinate bonding (FIG. 1A). Generally, the displacement reaction may be modeled as Equation 1, below:

$$R - Me 1 + Me 2 < -- - > R - Me 2 + Me 1$$

where “R” denotes the polymer matrix with a fixed functional group capable of ionic or coordinate bonding with a mobile solute “Me1.” “Me1” is a solute that is initially bound to the functional group of “R,” and “Me2” is a solute present in the feed. As a result of the ion exchange reaction, “Me2” replaces the “Me1” on the resin. The solutes continue to migrate through the column and the ions continue to “hop” from one fixed ion (stationary phase) to the next. Once the beads have bound the target solutes from the feed, a desorbent is pumped through the reactor column to elute the target ions. The desorbent is selected based on feed composition, functional group chemistry, and the processing steps that will occur after the ion exchange process, but is often one of a few acids or bases.

The process described above may be alternatively depicted in simulated moving bed (SMB) column (FIG. 1B). During commercial chromatography, such as SMB and multi-column chromatograph, the feed flows through the column and solutes with stronger affinity for the stationary phase displacing solutes with weaker affinity for the stationary phase allowing for fractionation based on solute affinity. During this process, the non-target solutes may extract out before eluting the target solutes. In some embodiments, a diluent or eluent may be pushed through the column to allow the release of the target solute. Such commercial methods continue to have drawbacks associated to bead-based methods.

For example, common issues associated with bead-based separation methods include resin fouling, oxidation, thermal resin degradation, inadequate regeneration, channeling, and resin loss or migration. However, a material to not only improve bed packing efficacy of ion exchange columns but also improve flow rates and achieve single-pass purities is highly desired. Such improvements may have a multitude of improvements to current technologies including reduction in plant footprint, reduction in environmental footprint, reduction in capital investment, and reduction in operating costs compared to existing technologies.

Thus, described herein are materials and methods for use in column chromatography techniques. Such materials, described below, may have productivities (defined herein as mass of target mineral separated per volumetric flow rate) of greater than three kilograms per liter of bed volume per hour. In some embodiments described herein, such materials may have flow rates of greater than 30 bed volume per hour. In some embodiments, the materials described herein may have 100% retention in the columns. Additionally, the materials and methods described herein may have efficient flow through without the formation of the channel effect through the column. Similarly, the methods described herein may have reduced aggregation, reduced non-specific interactions, and reduced denaturation in protein separations. Similarly, the methods and columns described herein may result in reduced pressure drops across the column, higher flow rates compared to standard chromatography methods, and significantly reduced back pressure.

### Definitions

A number of terms and concepts are discussed below. They are intended to facilitate the understanding of various embodiments of the present disclosure in conjunction with the rest of the present document and the accompanying figures. These terms and concepts may be further clarified and understood based on the accepted conventions in the fields of the present disclosure, as well as the description provided throughout the present document and/or the accompanying figures. Some other terms can be explicitly or implicitly defined in other sections of this document and in the accompanying figures and may be used and understood based on the accepted conventions in the fields of the present disclosure, the description provided throughout the present document, and/or the accompanying figures. The terms not explicitly defined can also be defined and understood based on the accepted conventions in the fields of the present disclosure and interpreted in the context of the present document and/or the accompanying figures.

Unless otherwise defined, all terms of art, notations, and other scientific terms or terminology used herein are intended to have the meanings commonly understood by those of ordinary skill in the art. In some cases, terms with commonly understood meanings are defined herein for clarity and/or for ready reference, and the inclusion of such definitions herein should not be construed as representing a substantial difference over the definition of the term as generally understood in the art.

As used herein, the term “composition” refers to a product comprising the specified ingredients in the specified amounts, as well as any product, which results, directly or indirectly, from combination of the specified ingredients in the specified amounts.

As used herein, the terms “including,” “comprising,” “having,” “containing,” and variations thereof, are inclusive and open-ended and do not exclude additional, unrecited elements or method steps beyond those explicitly recited. As used herein, the phrase “consisting of” is closed and excludes any element, step, or ingredient not explicitly specified. As used herein, the phrase “consisting essentially of” limits the scope of the described feature to the specified materials or steps and those that do not materially affect the basic and novel characteristics of the disclosed feature.

Articles “a” and “an” are used herein to refer to one or to more than one (i.e., at least one) of the grammatical object of the article. By way of example, “an element” means at least one element and can include more than one element.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combination of numerical values between and including the lowest value and the highest value enumerated are to be considered to be expressly stated in this disclosure.

The terms “about” and “approximately” as used herein shall generally mean an acceptable degree of error for the quantity measured given the nature or precision of the measurements. Exemplary degrees of error are within 20% (%); preferably, within 10%; and more preferably, within 5% of a given value or range of values. Any reference to “about X” or “approximately X” specifically indicates at least the values X, 0.95X, 0.96X, 0.97X, 0.98X, 0.99X, 1.01X, 1.02X, 1.03X, 1.04X, and 1.05X. Thus, expressions “about X” or “approximately X” are intended to teach and provide written support for a claim limitation of, for example, “0.98X.” Numerical quantities given herein are approximate unless stated otherwise, meaning that the term “about” or “approximately” can be inferred when not expressly stated. When “about” is applied to the beginning of a numerical range, it applies to both ends of the range.

The term “minerals” as used herein shall generally mean any mineral, including, without limitation, precious metals (including, without limitation gold, silver, platinum, palladium, indium), minerals designated as “critical minerals” by the Secretary of the Interior, acting through the director of the U.S. Geological Survey, and uranium. For example, critical minerals can include, but are not limited to, aluminum, antimony, arsenic, barite, beryllium, bismuth, cerium, cesium, chromium, cobalt, dysprosium, erbium, europium, fluorspar, gadolinium, gallium, germanium, graphite, hafnium, holmium, indium, iridium, lanthanum, lithium, lutetium, magnesium, manganese, neodymium, nickel, niobium, palladium, platinum, praseodymium, rhodium, rubidium, ruthenium, samarium, scandium, tantalum, tellurium, terbium, thulium, tin, titanium, tungsten, vanadium, ytterbium, yttrium, zinc, and zirconium.

The term “nutraceuticals” is used herein to refer to food components or dietary supplements that provide health benefits beyond their nutritional value. For example, nutraceuticals may be used to refer to compounds such as vitamin c, omega-3 fatty acids, probiotics, garlic extract, green tea extract, coenzyme Q, carnitine, vitamins, minerals, prebiotics, carotenoids, monoterpenes, phytosterols, anthocyanins, flavones, stilbenes, and isoflavones. The term may be used to imply a pharmaceutical effect from a compound or food product that has not been scientifically confirmed or approved to have clinical benefits. Similarly, nutraceuticals may offer a range of potential health benefits. In some non-limiting examples, the nutraceuticals may reduce the risk of chronic disease such as heart disease, cancer and diabetes, improving immune function, promoting cognitive health, and reducing stress and anxiety.

The term “feed” as used herein shall generally mean any heterogenous solution that contains the target solute or target solutes (herein also referred to as mineral, minerals, or proteins). For example, the feed in a wastewater treatment plant may be the wastewater that is to be treated to remove unwanted solutes for water recycling.

The term “desorbent” as used herein shall generally refer to any chemical or solution that may be flowed through the column to elute the target ions from a column or reactor. For example, desorbents may include water, acids, bases, salts, or other chemicals or solutions to elute a target bound to a stationary phase in a chromatography column separation.

The term “binding capacity” as used herein shall generally refer to the homotropic second derivative of the binding potential with respect to the chemical potential of the ligand. It may be used herein to refer to the measure of steepness of the binding isotherm and represents the extent of cooperativity.

As used herein “stationary phase” as used herein shall generally refer to a phase in chromatography columns of which does not move with the sample.

The term “eluent” as used herein shall generally refer to solvent or mobile phase that passes through a column and carries the sample components through the column, facilitating the separation.

The term “eluate” as used herein shall generally refer to a solution obtained be elution through a column. For example, the eluate is a mixture of the solute and solvent exiting the column.

The term “diluent” as used herein shall generally refer to compounds added to a mixture to further dilute or lower the concentration of the mixture.

The term “inert core” as used herein shall generally refer to a solid support surface that is produced from a polymer. The polymer core structure is non-porous and relatively chemically inert. Non-limiting examples of chemically inert polymers include perfluoroalkoxy, fluorinated ethylene propylene, and polytetrafluoroethylene.

### Woven and Non-Woven Polymer Mats

Described herein are materials used in chromatography techniques for the extraction and purification of target analytes. The materials may allow for enhanced reaction kinetics, leading to higher volumetric flow rates, better column packing efficacy, and improved purity from single-pass flows. In some embodiments, the target analyte is pharmaceuticals, nutraceuticals, petrochemicals, protein separations, the food industry, critical minerals, and municipal and industrial wastewater treatment, among many others. In some embodiments, the material may be a woven or non-woven polymer mat. A woven polymer mat may refer to a mat that is fabricated by weaving together yarns of the polymer to form sheets or roles of the mat. The non-woven mat may refer to a mat produced by binding short and long fibers of the synthetic polymers together through needle punching or other alternative methods. The woven or non-woven polymer mat can be produced from polysulfones, polyamides, polyimides, polyamideimides, polyaramids, polyesters, polycarbonates, polyethylene, polypropylene, or any combination thereof. For example, the woven or non-woven polymer mat may be produced from polypropylene. In some embodiments, the material may be used in ion exchange chromatography.

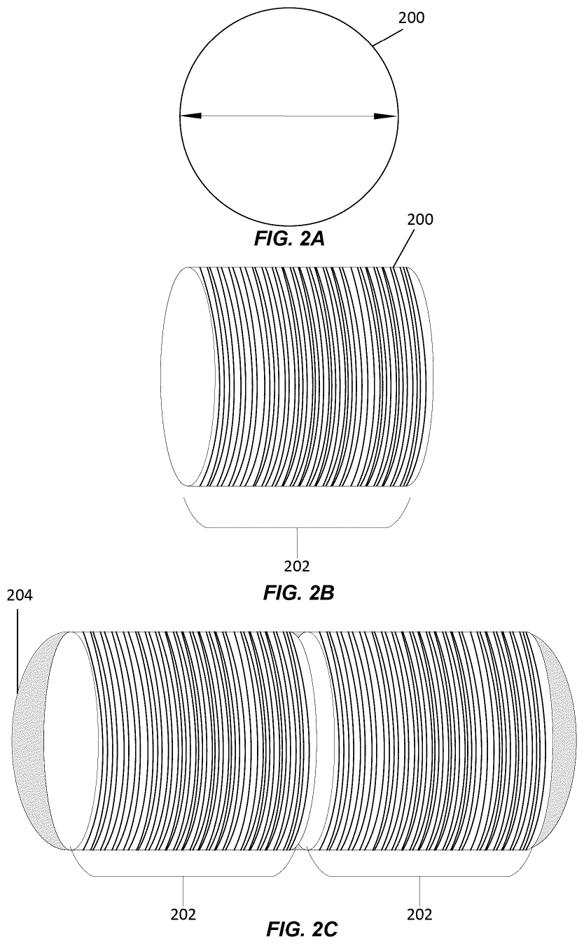

The woven or non-woven polymer mat may generally be produced as sheets or rolls in the industrial setting. For use in the methods described below, the sheets of woven or non-woven polymer may be punched, or otherwise cut, into a disk having a specific diameter (FIG. 2A). In some embodiments, the mat may be punched or cut into any other shape or configuration to produce a packing material within a column. In some embodiments, the diameter of the disk 200 may be from about 0.5 inches to about 300 inches. The diameter of the disk 200 may be selected based at least in part on the application to be employed. For example, research-related columns may have a small diameter of 0.5 inches, while an industrial-sized column may have a diameter of up to 300 inches. For example, the diameter of the disk 200 may be from 0.5 inches to 300 inches, from 1 inch to 150 inches, from 10 inches to 150 inches, or from 25 inches to 250 inches. Thus, the diameter in which the disk 200 is cut may be selected by the user prior to incorporation into the column and further processed according to the methods described below. For example, in typical simulated moving bed (SMB) chromatography, the column may have a diameter greater than 5 meters (˜197 inches), thus the materials described herein may be cut or otherwise punched into such a diameter. One skilled in the art would understand that the diameter of the woven or non-woven polymer may be cut to fit the inner diameter of a column. For example, as described above, research-grade columns may have a smaller diameter than industrial-sized columns. Thus, one skilled in the art would understand that the disks are cut from the mat to fit the inner diameter of the column whereby there is no gap between the edge of the disk and the inner wall of the column.

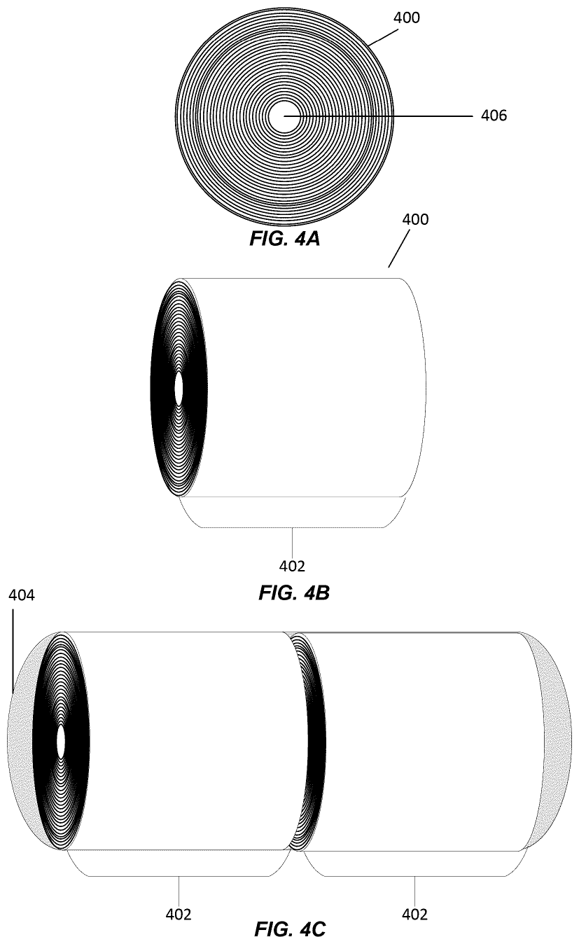

In some embodiments, the woven or non-woven mat may be rolled in a spiral configuration around a central inert core to produce a roll having from 1 to 1000 layers. For example, the spiral configuration is shown in FIG. 4A. The spiral configuration 400 may include a central inert core 406, and a woven or non-woven polymer may be wrapped or wound around the central inert core 406, to produce a roll. In some embodiments, the number of layers depends upon the diameter of the column. For example, as described above, the column having a diameter of 0.5 inches may have fewer layers than a column having a diameter of 300 inches. In other embodiments, the spiral configuration may not have an inert central core.

In some embodiments, the wound or spiral configuration may have an increased residence time compared to the disk configuration described herein.

In some embodiments, the woven or non-woven polymer mat may have enhanced retention of polar and non-polar compounds compared to bead-based methods. In some embodiments, the woven or non-woven polymer may have a column productivity that is at least two to ten times higher than resin-based chromatography stationary phases.

### Surface Functionalization

Also described herein are the woven or non-woven polymer mats that have undergone a surface functionalization. Surface functionalization may include modifying the surface of the woven or non-woven polymer to give the material a specific surface chemistry to increase the applicability to certain solutes as measured by functional group density (binding capacity). In some embodiments, the binding capacity of the woven or non-woven polymer subsequent to surface functionalization may be from about 0.1 to about 20 mg/mL. For example, from about 0.1 to 19 mg/mL, from about 0.2 to about 18 mg/mL. from about 0.4 to about 17 mg/mL, from about 0.6 to about 16 mg/mL, from about 0.8 to about 15 mg/mL, or from about 1 to about 14 mg/mL. In some embodiments, the binding capacity may be greater than 0.1, greater than 0.2 greater than 0.3, greater than 0.4, greater than 0.5, greater than 0.6, greater than 0.7, greater than 0.8, greater than 0.9, greater than 1, greater than 2, greater than 3, greater than 4, greater than 5, greater than 6, greater than 7, greater than 8, greater than 9, or greater than 10 mg/mL after surface functionalization.

In some embodiments, the surface chemistry can include carboxylic, aminophosphinic, phosphinic, iminodiacetic, sulfonates, bis-picolylamine, quaternary ammonium functional groups, primary amines, secondary amines, tertiary amines, polyamines comprised solely of secondary amines, polyamines comprised solely of tertiary amines, polyamines comprising a mixture of primary, secondary, and tertiary amines, phosphorylcholines, sulfobetaines, carboxybetaines, or any combination thereof.

In some embodiments described herein, the functionalization or surface modification of the porous material may further include the use of multiple synthesis steps to further alter the characteristics of the woven or non-woven polymer material. In some embodiments, primary or secondary amine or polyamine functionalized woven or non-woven mats may be further functionalized with compounds containing one or more epoxides, ketones, aldehydes, carboxylic acids, or alkyl halides. In some embodiments, these compounds may contain a linear or branched chain containing carbon, oxygen, or nitrogen atoms. In some embodiments, these second chains may contain multiple epoxides, ketones, aldehydes, carboxylic acids, or alkyl halides, thus enabling further functionalization. In another embodiment, woven or non-woven polymer materials chemically modified using polyamines and further modified with compounds containing multiple epoxides, ketones, aldehydes, carboxylic acids, or alkyl halides may be functionalized again with an amine, including a polyamine. Polyamines may be linear or branched, may contain primary, secondary, or tertiary amines or a mixture thereof, may contain between 2 and 10,000 primary, secondary, or tertiary amines (e.g., between 200 and 10,000, between 2000 and 10,000, between 5,000 and 10,000 and between 2 and 5,000 primary, secondary, or tertiary amines), and may have a molecular weight from 60 g/mol to 100,000 g/mol (e.g., from 600 g/mol to 100,000 g/mol, from 6,000 g/mol to 100,000 g/mol, from 60,000 g/mol to 100,000 g/mol, from 60 g/mol to 10,000 g/mol, from 60 g/mol to 1,000 g/mol, or from 60 g/mol to 100 g/mol). For example, polyamines used in such a series functionalization may include linear poly(ethyleneimine), branched poly(ethyleneimine), linear poly(propyleneimine), or branched poly(propyleneimine). In some embodiments, the series functionalization may utilize compounds with different characteristics. For example, woven or non-woven porous material modified using multiple polyamines may use a mixture of linear and branched polyamines, polyamines of different molecular weights, polyamines with different numbers of carbons in the alkyl chains between amine moieties, or some combination thereof. In some embodiments, the chemically modified woven or non-woven polymer material may be functionalized from 0 to 10 times (e.g., from 0 to 10, from 2 to 9, from 3 to 8, or from 4 to 7 times) to add additional chemical moieties to the surface of the woven or non-woven polymer material. In some embodiments, the chemically modified woven or non-woven polymer material may be functionalized 1 time, 2 times, 3 times, 4 times, 5 times, 6 times, 7 times, 8 times, 9 times, or 10 times. In some embodiments, additional processing steps may be required to tether functional groups to the surface of the woven or non-woven polymer geotextile. For example, to functionalize polyamine to the surface, 1,4-butanediol diglycidyl ether is used to tether the amine to the surface.

Often times surface chemistry is chosen based on a particular functional groups' selectivity for certain solutes over others-in the metallurgical space, according to Table 1. For example, as depicted in table 1, sulfonated surface chemistries may retain Fe³⁺ with a greater affinity than H⁺. Optionally, the surface chemistry may be modified such that the material may be used for fractionation in the manufacture of pharmaceuticals, nutraceuticals, petrochemicals, protein separations, the food industry, critical minerals, and municipal and industrial wastewater treatment, among many others. In some embodiments, the woven or non-woven polymer, and columns produced therefrom may be used in everyday organic synthesis systems.

TABLE 1
Surface chemistry selectivity for certain solutes.

| Surface Functionalization | Functional groups selectivity for certain solutes. |
|---|---|
| Carboxylic | Cu2+ > Pb2+ > Zn2+ > Cd2+ > Ni2+ > Ca2+ |
| Phosphonic | Cu2+ > Zn2+ > Cd2+ > Mn2+ > Co2+ > Ni2+ > Ca2+ |
| Aminophosphonic | Fe3+ > Bi3+ > Sb3+ > Pb2+ > Fe2+ > Zn2+ > Cu2+ > |
| | Mn2+ > Ca2+ > Mg2+ > Ni2+ > Co2+ > Na+ |
| Iminodiacetic | Cr3+ > In3+ > Fe3+ > Al3+ > Hg2+ > UO22+ > Cu2+ > Pb2+ > |
| | Ni2+ > Cd2+ > Zn2+ > Co2+ > Fe2+ > Mn2+ > Ca2+ > Mg2+ |
| Sulfonated | Fe3+ > Ca2+ > Fe2+ > Cu2+ > Mg2+ > K+ > NH4+ > Na+ > H+ |
| Bis-picolylamine | Cu2+ > Ni2+ > Fe3+ > Zn2+ > Co2+ > Cd2+ > Fe2+ > Mn2+ |
| Quaternary ammonium | SO4 2− > CO3 2− > NO3− > Cl− > HCO3− > F− > OH− |
| functional groups | |
| di-2-ethyl-hexyl-phosphoric acid | Fe3+ > Zn2+ > Ca2+ > Cd2+ > Mn2+ > Cu2+ > Mg2+ > Co2+ > Ni2+ |
| Bis-2,4,4-trimethylpentyl- | Fe3+ > V(IV) > Zn2+ > Al3+ > Cu2+ > Mn2+ > Co2+ > Mg2+ > |
| phosphinic acid | Ca2+ > Ni2+ |

Following selection of the surface chemistry as described above, the woven or non-woven polymer geotextile may undergo a process for functionalization. In some embodiments, the method for functionalization may be dependent upon the target analytes in the solution. For example, to accomplish sulfonation of the woven or non-woven polymer, a solution of H₂SO₄ may be first brought to a desired temperature. In some embodiments, the temperature of the solution may be raised from about 70° C. to about 140° C. (e.g., from about 70° C. to about 130° C., from about 80° C. to about 120° C., from about 90° C. to about 110° C., from about 70° C. to about 110° C., or from about 110° C. to about 140° C.). For example, the temperature may be 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., or 140° C.

In other embodiments, the temperature of the solution may be at ambient temperature during the soaking to functionalize the surface of the woven or non-woven polymer geotextile. Ambient temperature may refer to the temperature of the surrounding air. For example, ambient temperature may refer to room temperature (e.g., between 15° C. and 25° C.).

In some embodiments, the woven or non-woven polymer mat may be submerged in the solution for a duration of time sufficient enough to allow the entire surface of the polymer to obtain the desired surface chemistries. The time required for the process to reach completion may be dependent upon the desired surface functionalization. In some embodiments, the polymer may be submerged from about 10 minutes to about 3 hours to achieve the desired functionalization. For example, from about 10 minutes to about 30 minutes, from about 30 minutes to about 45 minutes, from about 45 minutes to about 60 minutes, from about 60 minutes to about 75 minutes, from about 75 minutes to about 90 minutes, from about 90 minutes to about 105 minutes, from about 105 minutes to about 120 minutes, from about 120 minutes to about 135 minutes, from about 135 minutes to about 150 minutes, from about 150 minutes to about 165 minutes or from about 165 minutes to about 180 minutes. In some embodiments, the woven or non-woven polymer mat may be submerged in the solution for up to 24 hours to ensure maximum surface functionalization.

In some embodiments, the surface functionalization of the woven or non-woven polymer mat may be performed before or after cartridge-ization and column-ization as described below. In some embodiments, the surface functionalization of the woven or non-woven polymer mat may be performed before the mat is punched into disks, prior to forming the spiral configuration, or directly after the mat is punched into a disk or layered around the inert central core. In one non-limiting example, the woven or non-woven mat is punched into a disk of desired diameter and the disks are submerged into the solution having the appropriate chemicals to functionalize the surface with the desired surface chemistry. The disks may then be subsequently removed from the solution and further processed as described below. Similarly, the woven or non-woven polymer may be un-wound from the roll, submerged as a long sheet into the solution, and subsequently removed from solution after surface functionalization.

### Methods of Preparation

Provided herein are methods for preparing the woven or non-woven polymer mat described in this disclosure for use in chromatography columns. More particularly, provided are methods for preparing the woven or non-woven polymer for use in ion exchange chromatography columns.

### Cartridge-Ization

In some embodiments, the woven or non-woven polymer mat may be prepared into disk cartridges 202 that include the disks or spiral cartridges 402 that include the rolled or layered woven-or non-woven mat. The process for forming a cartridge may include first punching or cutting the disks 200 out from the woven or non-woven polymer sheets. After the disk 200 is punched, the disk 200 may be turned on its side and placed into a holder. A series of disks 200 are placed together, such that one side of the disk 200 is in contact with a second disk 200 (FIG. 2B). This process produces a disk cartridge 202 having at least 2 disks in direct contact with one another. In some embodiments, the disk cartridge 202 may have from about 2 to about 1000 disks in physical connection to one another. Similarly, as depicted in FIG. 4B, in the spiral configuration, the woven or non-woven polymer geotextile mat may be wound around a central inert core 406. The spiral configuration may have from 1 to 1000 layers. In some embodiments, the spiral cartridge 402 may be cut into the specified length of the column, or to the desired length for a separation method to produce a spiral cartridge 402. Following the winding of the woven or non-woven polymer geotextile around the central inert core 406, an epoxy resin is then applied to the outer edge of the cartridge to form a watertight seal around the cartridge. In some embodiments, the spiral cartridge 402 may be painted with, sprayed with, or submerged in the epoxy, or otherwise have epoxy applied, producing a coating surrounding 100% of the cartridge. The circular ends of the cartridge at the topmost edge and the bottom most edge may be cut from the cartridge to produce a flow through channel within the cartridge. In some embodiments, the epoxy resin used can include epoxide-containing phenolic resins that may include a combination of the epoxide-containing backbone with a polyamine crosslinking agent. In some embodiments, they may be referred to by trade names including, but not limited to, Novolac #633 chemical resistant epoxy. Other suitable epoxy resins may include Novolac #630 or vinyl ester #663 epoxies, commercially available from Key Resin Company, Batavia, OH, and other commercial vendors. In some embodiments, the epoxy resin to be used may be an epoxy resin that has high chemical resistance and solvent resistance. For example, modified cycloaliphatic amine cured epoxies may be used.

Following the selection of the desired number of disks within the disk cartridge 202, the disk cartridge 202 may be pressed together, an epoxy resin is then applied to the outer edge of the cartridge to form a watertight seal around the cartridge. In some embodiments, the cartridge may be pressed together under a pressure of from 0 to about 60 PSI. In some embodiments, the disk cartridge 202 may be painted with, sprayed with, or submerged in the epoxy, or otherwise have epoxy applied, producing a coating surrounding 100% of the cartridge. The circular ends of the cartridge at the topmost edge and the bottom most edge may be cut from the cartridge to produce a flow through channel within the cartridge. In some embodiments, the epoxy resin used can include Novolac #633 chemical resistant epoxy. Other suitable epoxy resins may include Novolac 630 or vinyl ester 663 epoxies. In some embodiments, the epoxy resin to be used may be an epoxy resin that has high chemical resistance and solvent resistance. For example, modified cycloaliphatic amine cured epoxies may be used.

Once the cartridge is generated, the surface of the woven or non-woven polymer mat may be functionalized according to the methods described above to produce a cartridge with the desired surface functionalization. In some embodiments, the method may include pouring or flowing, through the cartridge, the warmed treatment solution to accomplish the desired surface chemistry. The warmed treatment solution may be heated to a temperature of about 70° C. to about 140° C. For example, the temperature may be 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., or 140° C. For example, performing sulfonation of polypropylene, the solution is warmed to allow surface functionalization. In other embodiments, the temperature of the solution may be at ambient temperature during the soaking to functionalize the surface of the woven or non-woven polymer geotextile. Ambient temperature may refer to the temperature of the surrounding air. For example, ambient temperature may refer to room temperature (e.g., between 15° C. and 25° C.). For example, in polyamine functionalization, the solution may be maintained at room temperature to allow functionalization. In some embodiments, heating the solution to a temperature as described above may enable higher reaction rates with the woven or non-woven geotextile described herein.

In some embodiments, the surface chemistry can include carboxylic, aminophosphinic, phosphinic, iminodiacetic, sulfonates, bis-picolylamine, quaternary ammonium functional groups, primary amines, secondary amines, tertiary amines, polyamines comprised solely of secondary amines, polyamines comprised solely of tertiary amines, polyamines comprising a mixture of primary, secondary, and tertiary amines, phosphorylcholines, sulfobetaines, or carboxybetaines, or any other functional groups (e.g., solvent impregnated and/or chelating groups). After a sufficient time is passed, the functionalization treatment is quenched and the cartridge may be tested for its binding capacity. For example, the binding capacity may be tested by any methods known by those skilled in the art, such as titration methods. In some embodiments, the binding capacity of the woven or non-woven polymer subsequent to surface functionalization may be from about 0.1 to about 20 mg/mL. For example, from about 0.1 to 19 mg/mL, from about 0.2 to about 18 mg/mL. from about 0.4 to about 17 mg/mL, from about 0.6 to about 16 mg/mL, from about 0.8 to about 15 mg/mL, or from about 1 to about 14 mg/mL. In some embodiments, the binding capacity may be greater than 0.1, greater than 0.2 greater than 0.3, greater than 0.4, greater than 0.5, greater than 0.6, greater than 0.7, greater than 0.8, greater than 0.9, greater than 1, greater than 2, greater than 2, greater than 4, greater than 5, greater than 6, greater than 7, greater than 8, greater than 9, or greater than 10 mg/mL after surface functionalization.

### Column-ization

Also provided herein are methods of forming disk columns 204 of the woven or non-woven polymer disk as described herein and shown in FIG. 2C. Similarly, described herein are methods of forming spiral cartridges 402 of the woven or non-woven polymer as described herein and shown in FIG. 4C. In some embodiments, the column is produced by first equilibrating a chromatographic column and at least one cartridge to the same or similar temperature. For example, the temperature of the column and cartridge may be first brought to about 0° C. to about 160° C. In some embodiments, the temperature may be first brought to 30° C. to about 160° C. before the cartridge may be installed into the column.

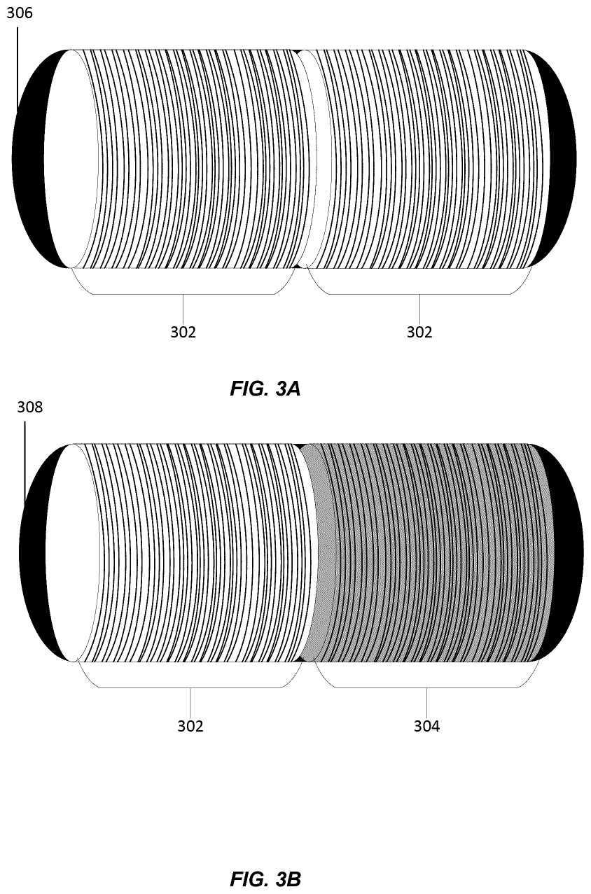

Following equilibration of the disk column 204, disk cartridges 202, spiral column 404, spiral cartridges 402, the at least one cartridge may be installed into the column. In some embodiments, the column may include from at least 1 cartridge to about 10 cartridges. In some embodiments, the number of cartridges in one column may depend on the size of the column. For example, in multi-column systems different cartridges may be placed in separate columns connected in series with one another. The column may be customized to fit a specific process in which the user is performing. Referring now to FIGS. 3A and 3B, the column may be made up of cartridges that have the same surface chemistry functionalization 306. Alternatively, if the separation technique requires an alternate method for ion exchange, the column may be prepared having a first cartridge 302 installed having a first functionalization and then a second cartridge 304 installed having a second functionalization that is different from the first functionalization thereby producing a column having alternating cartridges 308. In some embodiments, the column may be made up of cartridges prepared having the spiral configuration that have the same surface functionalization. Similarly, the column may be made up of cartridges having different surface chemistry functionalization.

A buffer is subsequently added to the column to remove any trapped air within the column and ensure the column is consistently void of air pockets until the column is ready to be used. In some embodiments, the buffer selected for the column is selected based upon if the operation is a cation exchange chromatography or an anion exchange chromatography. For example, common buffers used in cation exchange chromatography include citric acid, lactic acid, acetic acid, 2-(N-Morpholino) ethanesulfonic acid (MES), N-(2-Acetamido)-2-iminodiacetic acid (ADA), 3-(N-Morpholino) propanesulfonic acid (MOPS), N-(2-Hydroxyethyl) piperazine-N′-(2-ethanesulfonic acid) (HEPES), phosphate, or bicine. In some embodiments, buffers used in anion exchange chromatography can include N-Methylpiperazine, Piperazine, L-Histadine, bis-Tris, bis-tris propane, triethanolamine, Tris, N-Methyldiethanolamine, Diethanolamine, 1,3-Diaminopropane, Ethanolamine, Piperazine, and piperdine, imidazole, N-ethylmorpholine, triethanolamine, 2-amino-2-methyl-1,3-propanediol, or 2-amino-2-methyl-1-propanol.

In some embodiments, the use of cartridges as described herein may result in a column having a more uniform packing than ion exchange resin, allowing for consistent flow paths. The cartridges packed into the column may reduce column backpressure resulting from trapped air bubbles. For example, the columns produced from the cartridges described herein may have less air bubbles inside of the column when compared to bead-based methods of column chromatography. In some embodiments, the columns may have consistent retention times, improved column efficiency, and consistent column selectivity. For example, the columns described herein may have single pass purities that are higher than existing bead-based methods.

By providing cartridges as described herein for chromatography applications, the time required to pack the column and the cost associated may be minimized. In some embodiments, the cartridges may be functionalized for a selected surface chemistry and subsequently loaded into the selected column length. The cartridges may be slide into the column such that the cartridge diameter makes contact with the inner diameter of the column to create a seal within the column. In some embodiments, more than one cartridge may be placed in one column. In some embodiments, the column may have more than one cartridge inserted within the column.

In some embodiments, the column may have a flow rate that is higher than existing bead-based methods of separation. For example, the flow rate may be at least 30 bed volume per hour at low pressure. In some embodiments, the flow rate may be from 10 bed volumes to about 40 bed volumes per hour. For example, in simulated moving bed chromatography columns the flow rate may be up to 1000 m³/hour. Bed volume may be used herein to refer to the volume per hour of liquid to be treated over the volume of resin. The term may be understood by those skilled in the art as a measure of flow rate through a column.

In some embodiments, the chromatographic column prepared according the methods and materials described herein may have a flow rate of from 0.01 m³/hr to 1000 m³/hr. For example, the flow rate may be from 0.01 m³/hr to 900 m³/hr, from 0.10 m³/hr to 900 m³/hr, from 0.10 m³/hr to 800 m³/hr, from 1 m³/hr to 800 m³/hr, from 1 m³/hr to 700 m³/hr, from 10 m³/hr to 1000 m³/hr, from 100 m³/hr to 1000 m³/hr, or from 500 m³/hr to 1000 m³/hr. In some embodiments, the chromatographic column prepared according the methods and materials described herein may have a flow rate of greater than 0.01 m³/hr, greater than 0.10 m³/hr, greater than 1 m³/hr, greater than 10 m³/hr, greater than 100 m³/hr, greater than 200 m³/hr, greater than 400 m³/hr, or greater than 800 m³/hr.

In some embodiments, the flow rate may be calculated or otherwise estimated by employing a number of modified equations. For example, using Hagen-Poiseuille calculations an estimation of flow rate may be determined. The Hagen-Poiseuille equation may be represented by equation 1:

$$Δ P = \frac{8 μ LQ}{π {R}^{4}}$$

where ΔP is the pressure drop, is the dynamic velocity, L is the tube/bed length, Q is the volumetric flow rate, and R is the tube radius. As the material utilized in the systems described herein do not have well defined “tubes,” R may be defined as R_{eff}, denoting the effective tube or pipe radius, resulting in Equation 2:

$$Δ P = \frac{8 μ LQ}{π {R}_{{eff}^{4}}}$$

If two columns are packed with identical materials which are assumed to be uniform along the length of the column, with an identical fluid flowing through the bed, then equation 3 may be assumed:

μ₁=μ₂

and therefore equation 4 is also true:

R_{eff,1}=R_{eff,2}.

Therefore, if equation 5 as shown blow;

ΔP₁=ΔP₂

Then equation 6 must also be true:

$$\frac{8 {μ}_{1} {L}_{1} {Q}_{1}}{π {R}_{eff , 1}^{4}} = \frac{8 {μ}_{2} {L}_{2} {Q}_{2}}{π {R}_{eff , 2}^{4}} .$$

When equations 3 and 4 are taken into account, Equation 6 then becomes

$${L}_{1} {Q}_{1} \frac{8 μ}{π {R}_{eff}^{4}} = {L}_{2} {Q}_{2} \frac{8 μ}{π {R}_{eff}^{4}}$$

Which may be further simplified to equation 8:

L₁Q₁=L₂Q₂.

Therefore, from existing literature values utilizing the standard test for evaluating geotextile permeability (ASTM D-4491) it is possible to evaluate the pressure drop, and thus the volumetric flow rate for a longer column may be calculated. For example, using an ASTM D-4491 permeation test where Q is 5080 L/min/m² (0.08467 m³/s/m²), and L is 0.002 m for a constant single-layer water head of 0.05 m, corresponding to a single-layer pressure drop of 490.5 Pa. Therefore, to achieve a 1 bar pressure drop where Q is 5080 L/min/m², it may be necessary to have a bed thickness of 203.87 layers, or 0.4077 m. Thus, using equation 8, Q₂ may be 0.01726 m³/s/m² for a 2-meter-tall column at 1 bar pressure drop. Therefore, the following table may represent estimated volumetric flow rates using the methods and materials described herein in a uniformly packed, 2 meter tall, chromatography column at 1 bar pressure drop.

TABLE 2
Estimated flow rates for various column diameters.

| Column Diameter | Column cross- | Volume flow | Volume flow |
|---|---|---|---|
| (m) | sectional area (m²) | (m³/s) | (m³/hour) |
| 0.5 | 0.196 | 0.00339 | 12.2 |
| 1 | 0.785 | 0.0135 | 48.8 |
| 1.5 | 1.77 | 0.0305 | 109 |
| 2 | 3.14 | 0.0542 | 195 |
| 2.5 | 4.91 | 0.0847 | 305 |
| 3 | 7.07 | 0.122 | 439 |
| 3.5 | 9.62 | 0.166 | 597 |
| 4 | 12.6 | 0.217 | 780 |
| 4.5 | 15.9 | 0.274 | 988 |

The columns and/or cartridges described herein may be used in a number of chromatography techniques including simulated moving bed (SMB), continuous ion exchange, and multi-column chromatography systems. In some embodiments, the process may include a pre- or post-treatment using, the non-woven, woven, bundles of staple fiber, or spiral-wound sheets of the polymer mat described herein.

### Ion Exchange Chromatography

Provided herein are methods of performing ion exchange chromatography. The ion exchange method described herein is merely to serve as an example for using the woven or non-woven polymer mat, cartridges, or columns as described herein. One skilled in the art may understand that modifications, alterations, or substitutions to the method described may be used incorporating the novel material described herein.

Cartridges are first prepared as described above and placed in configurations of four or more match or continuous reactors (typically, columns) arranged in a circuit (“primary circuit”). A feed containing the target solute(s) and any additional impurities are then flowed through the cartridges/columns. The solutes in the feed fractionate into bands of relatively high purity based on any number of mechanisms. For example, how strongly or weakly each solute interacts with the functional groups tethered to the fiber mats (solutes with stronger electrostatic properties can and do often displace solutes with weaker electrostatic properties already bound to a functional group); Steric hindrance that slows down solutes with large ionic or molecular radii (whether hydrated or un-hydrated; hydrophobicity that retards solutes with stronger hydration enthalpies; and electrostatic repulsion from solutes bound to a functional group with a like charge as the solute being repelled.

Each feed may be initially evaluated to determine the maximum amount of feed that can be introduced to the reactor without affecting the reaction kinetics (the “Max Feed”). Each column or vessel in the Primary Circuit may be fed with no more than the Max Feed before switching the feed to another column in the Primary Circuit and repeating the process. The fraction from the loaded Cartridge that contains the target analyte (the “Extract”) may be pumped into another column to further the fractionation, or to another zone to remove any impurities (the “Purifying Circuit”). The balance of the feed that does not contain material concentrations of the target analyte (the “Raffinate”) may be pumped out of the system. Either or both of the Extract and Raffinate may require a desorbent/eluent pumped through the Cartridge to further the fractionation mechanism, release bound analytes, and/or regenerate the column for another fractionation cycle. Desorbents used in this process can include water, acids, bases, or other eluents. Such a desorbent stage occurs in parallel with other unit operations in the Primary Circuit (and Purifying Circuit, if there is one in the process flow), including feed inlet, Extract recovery, Raffinate removal, desorbent injection, and column regeneration.

If the raffinate from the Purifying Circuit contains any of the target analytes it may be recycled into the Primary Circuit. In some embodiments, the feed may contain more than one target analyte which may be separated with multiple extract ports or a column cascade. In some embodiments, the cartridges can be “charged” with an analyte in advance of receiving the feed to aid in facilitating fractionation of the target analyte from the raffinate. Once removal of the target analyte is successful the process may be repeated on a new batch of feed (if performed in a batch operation). In some embodiments, the target analyte may be precious metals (typically from sodium cyanide leachate feeds), base metals (often from sulfuric acid-based leachates), lithium extraction (from brines highly concentrated in chloride and/or sulfate salts), pharmaceuticals, nutraceuticals, petrochemicals, protein separations, the food industry, and municipal and industrial wastewater treatment, among many others.

Methods for testing the raffinate can include any known technique used for testing critical minerals in solution.

### EXAMPLES

### Example 1: Construction of Columns for Chromatography Experiments

Columns were prepared according to the procedure discussed herein for use in functionalization and protein separation experiments. In brief, polyethylene terephthalate nonwoven discs of 1.375 inches were cut from a larger sheet. These discs were subsequently stacked and clamped in place, after which they were converted into a column via application of a Novolac-based epoxy to the exterior of the stack of discs. Appropriate fittings for the chromatographic application were then epoxied to either end of the column after the epoxy had cured. Once the epoxy cured, the column was further prepared for testing, including loading appropriate buffers.

### Example 2: Preparation of Polyamine-Tethered Non-Woven Materials

Polyamine-tethered polyethylene terephthalate nonwovens were prepared according to the method described herein. Briefly, in a first step, an aqueous solution containing 1 vol % of 10 kDa poly(ethyleneimine) was prepared. The column was then exposed to the aqueous poly(ethyleneimine) solution at ambient temperature for a minimum of 24 hours, after which the column was drained and washed with deionized water. A saturated aqueous solution of 1,4-butanediol diglycidyl ether was then prepared. The solution was then added to the column, where it was permitted to react with the poly(ethyleneimine)-tethered column under ambient conditions for a minimum of 24 hours. The 1,4-butanediol diglycidyl ether solution was then removed from the column, after which the column was again functionalized using the aqueous poly(ethyleneimine) solution and procedure described herein.

### Example 3: Protein Separations Using the Polyamine-Tethered Non-Woven Columns

The polyamine-tethered nonwoven columns were prepared according to the procedure described above in Example 2. The columns were washed and stored in 20 mM Tris-HCl buffer prior to experimentation. A ternary protein mixture, comprised of 0.3 mg/mL lysozyme, 0.3 mg/mL bovine serum albumin, and 0.3 mg/mL hemoglobin in 20 mM Tris-HCl buffer was prepared, and 10 mL of solution was introduced to the column. The column was then drained and washed with fresh 20 mM Tris-HCl buffer until the measured protein concentration in the eluent reached 0 mg/mL.

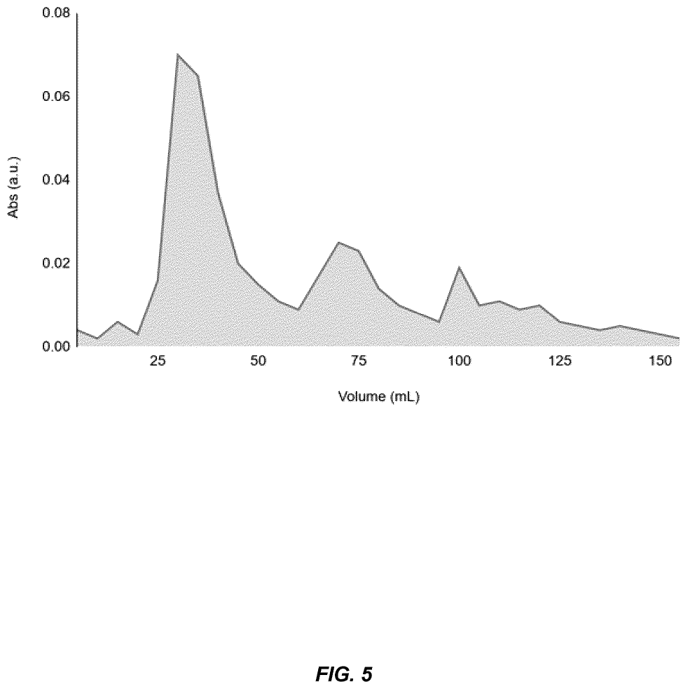

After a 0 mg/mL protein column eluent measurement, 50 mL of 0.1 M NaCl in 20 mM Tris-HCl buffer was added to the column to desorb the lysozyme. Once an appropriate dead period passed, aliquots of 5 mL column eluent were collected for characterization via UV-Vis. Subsequent 50 mL volumes of 0.25 M and 0.5 M NaCl in 20 mM Tris-HCl buffer were added to the column once the buffer level reached the top of the non-woven “bed” to desorb the hemoglobin and bovine serum albumin, respectively. FIG. 5 shows the desorption chromatogram of the bind and elute experiments. The graph shows the volume eluted from the column on the x-axis and the absorbance measured from each aliquot on the y-axis. The three distinct absorbance peaks correspond to the elution of each protein studied herein, with the first peak being attributable to lysozyme, desorbed with the 0.1 M NaCl solution, the second peak corresponding to hemoglobin, desorbed with the 0.25 M NaCl solution, and the final peak attributable to bovine serum albumin, desorbed with the 0.5 M NaCl solution. The results demonstrate successful separation of three distinct proteins using a single column separation method.

### Exemplary Embodiments

As used below, any reference to a series of embodiments is to be understood as a reference to each of those embodiments disjunctively (e.g., “Embodiments 1-4” is to be understood as “Embodiments 1, 2, 3, or 4”).

Embodiment 1 is a porous material for chromatography separation comprising: a woven or non-woven polymer, wherein the woven or non-woven polymer has a modified surface chemistry to produce a modified porous material, wherein the modified surface chemistry increases a binding capacity of a target analyte.

Embodiment 2 is the porous material of any preceding or subsequent embodiment, wherein the woven or non-woven polymer comprises polysulfones, polyamides, polyimides, polyamideimides, polyaramids, polyesters, polycarbonates, polyethylene, polypropylene, or any combination thereof.

Embodiment 3 is the porous material of any preceding or subsequent embodiment, wherein the modified porous material is punched into a disk or wherein the modified porous material mat is wound around an inert core to produce a layered structure, wherein the layered structure has from 1 to 1000 layers.

Embodiment 4 is the porous material of any preceding or subsequent embodiment, wherein the mat has a diameter of from 0.5 inches to about 300 inches.

Embodiment 5 is the porous material of any preceding or subsequent embodiment, wherein the surface chemistry comprises at least one functional group, wherein the functional group is carboxylic, aminophosphonic, aminophosphinic, phosphonic, phosphinic, iminodiacetic, sulfonic, bis-picolylamine, quaternary ammonium, phosphorylcholines, sulfobetaines, carboxybetaines, linear polypropyleneimine, branched polypropyleneimine, linear polyethyleneimine, branched polyethyleneimine, zwitterionic, or amphoteric functional groups or any combination thereof.

Embodiment 6 is the porous material of any preceding or subsequent embodiment, wherein the surface chemistry has a binding capacity of from 0.1 to 20 mg/mL.

Embodiment 7 is a method for modifying a porous material comprising producing a disk or a spiral configuration comprising a woven or non-woven polymer; and contacting the disk or spiral configuration with a solution or series of solutions, wherein the solution or series of solutions functionalizes the disk or spiral configuration with a surface chemistry for selected extraction.

Embodiment 8 is the method of any preceding or subsequent embodiment, wherein the woven or non-woven polymer comprises polysulfones, polyamides, polyimides, polyamideimides, polyaramids, polyesters, polycarbonates, polyethylene, polypropylene, or any combination thereof.

Embodiment 9 is the method of any preceding or subsequent embodiment, wherein the disk has a diameter of from 0.5 inches to about 300 inches, or wherein the spiral configuration comprises: an inert central core; and the woven or nonwoven polymer layered around the inert central core comprises from 1 to 1000 layers.

Embodiment 10 is the method of any preceding or subsequent embodiment, wherein the surface chemistry comprises carboxylic, aminophosphonic, aminophosphinic, phosphonic, phosphinic, iminodiacetic, sulfonic, bis-picolylamine, quaternary ammonium, phosphorylcholines, sulfobetaines, carboxybetaines, linear polypropyleneimine, branched polypropyleneimine, linear polyethyleneimine, branched polyethyleneimine, zwitterionic, or amphoteric functional groups or any combination thereof.

Embodiment 11 is a method of producing a cartridge comprising: providing a mat comprising a woven or non-woven polymer; stacking at least two disks punched from the mat or winding the mat around an inert core to produce a spiral configuration; optionally pressing the stack of at least two disks together; applying an epoxy to an outer diameter of the stacked disks or an outer layer of the spiral configuration, wherein the epoxy cures to form a waterproof seal around the outer diameter of the stacked disks or forms a waterproof seal around the outermost layer of the spiral configuration.

Embodiment 12 is the method of any preceding or subsequent embodiment, wherein stacking comprises stacking from at least 2 to 1000 disks, or wherein the winding comprises producing a spiral configuration comprising from 1 to 1000 layers.

Embodiment 13 is the method of any preceding or subsequent embodiment, wherein the stack of at least two disks are pressed together under pressure, wherein the pressure used for forming the stack is from 0 to 60 PSI.

Embodiment 14 is the method of any preceding or subsequent embodiment, wherein the epoxy comprises Novolac 630, Novolac 633, vinyl ester 663 epoxies, or any combination thereof.

Embodiment 15 is the method of any preceding or subsequent embodiment, wherein the woven or non-woven polymer comprises polysulfones, polyamides, polyimides, polyamideimides, polyaramids, polyesters, polycarbonates, polyethylene, polypropylene, or any combination thereof.

Embodiment 16 is the method of any preceding or subsequent embodiment, wherein the disks have a diameter of from 0.5 inches to about 300 inches, or wherein the woven or non-woven polymer layered around the inert central core has from 1 to 1000 layers in the spiral configuration.

Embodiment 17 is the method of any preceding or subsequent embodiment, wherein the method further comprises a treatment step wherein the cartridge is treated with a solution to functionalize the woven or non-woven polymer, wherein the treatment comprises: heating the solution to a temperature appropriate for the treatment of the cartridge; pouring or flowing the heated solution into the cartridge to functionalize the woven or non-woven polymer for a selected surface chemistry.

Embodiment 18 is the method of any preceding or subsequent embodiment, wherein the selected surface chemistry comprises at least one functional group, wherein the functional group is carboxylic, aminophosphonic, aminophosphinic, phosphonic, phosphinic, iminodiacetic, sulfonic, bis-picolylamine, quaternary ammonium, phosphorylcholines, sulfobetaines, carboxybetaines, linear polypropyleneimine, branched polypropyleneimine, linear polyethyleneimine, branched polyethyleneimine, zwitterionic, or amphoteric functional groups or any combination thereof.

Embodiment 19 is a method of generating a column of a modified porous substrate material comprising: equilibrating a chromatographic column and at least one cartridge to a temperature; installing the cartridge of any preceding or subsequent embodiments into the chromatographic column; filling the chromatographic column with a fluid, a priming solution, or a buffer; and enclosing the chromatographic column, wherein the chromatographic column has a flow rate of from 0.01 m³/hour to 1000 m³/hour.

Embodiment 20 is the method of any preceding or subsequent embodiment, wherein the buffer is citric acid, lactic acid, acetic acid, 2-(N-Morpholino) ethanesulfonic acid (MES), N-(2-Acetamido)-2-iminodiacetic acid (ADA), 3-(N-Morpholino) propanesulfonic acid (MOPS), N-(2-Hydroxyethyl) piperazine-N′-(2-ethanesulfonic acid) (HEPES), phosphate, bicine, N-Methylpiperazine, Piperazine, L-Histadine, bis-Tris, bis-tris propane, triethanolamine, Tris, N-Methyldiethanolamine, Diethanolamine, 1,3-Diaminopropane, Ethanolamine, Piperazine, and piperdine, imidazole, N-ethylmorpholine, triethanolamine, 2-amino-2-methyl-1,3-propanediol, 2-amino-2-methyl-1-propanol, or any combination thereof.

1. A porous material for chromatography separation comprising:
a woven or non-woven polymer, wherein the woven or non-woven polymer has a modified surface chemistry to produce a modified porous material, wherein the modified surface chemistry increases a binding capacity of a target analyte.

2. The porous material of claim 1, wherein the woven or non-woven polymer comprises polysulfones, polyamides, polyimides, polyamideimides, polyaramids, polyesters, polycarbonates, polyethylene, polypropylene, or any combination thereof.

3. The porous material of claim 1, wherein the modified porous material is punched into a disk or wherein the modified porous material is wound around an inert core to produce a layered structure, wherein the layered structure has from 1 to 1000 layers.

4. The porous material of claim 3, wherein the disk has a diameter of from 0.5 inches to about 300 inches.

5. The porous material of claim 1, wherein the surface chemistry comprises at least one functional group, wherein the functional group is carboxylic, aminophosphonic, aminophosphinic, phosphonic, phosphinic, iminodiacetic, sulfonic, bis-picolylamine, quaternary ammonium, phosphorylcholines, sulfobetaines, carboxybetaines, linear polypropyleneimine, branched polypropyleneimine, linear polyethyleneimine, branched polyethyleneimine, zwitterionic, or amphoteric functional groups or any combination thereof.

6. The porous material of claim 5, wherein the surface chemistry has a binding capacity of from 0.1 to 20 mg/mL.

7. A method for modifying a porous material comprising:
producing a disk or a spiral configuration comprising a woven or non-woven polymer; and
contacting the disk or spiral configuration with a solution or series of solutions, wherein the solution or series of solutions functionalizes the disk or spiral configuration with a surface chemistry for selected extraction.

8. The method of claim 7, wherein the woven or non-woven polymer comprises polysulfones, polyamides, polyimides, polyamideimides, polyaramids, polyesters, polycarbonates, polyethylene, polypropylene, or any combination thereof.

9. The method of claim 7, wherein the disk has a diameter of from 0.5 inches to about 300 inches, or wherein the spiral configuration comprises:
an inert central core; and
the woven or non-woven polymer layered around the inert central core comprises from 1 to 1000 layers.

10. The method of claim 7, wherein the surface chemistry comprises at least one functional group, wherein the functional group is carboxylic, aminophosphonic, aminophosphinic, phosphonic, phosphinic, iminodiacetic, sulfonic, bis-picolylamine, quaternary ammonium, phosphorylcholines, sulfobetaines, carboxybetaines, linear polypropyleneimine, branched polypropyleneimine, linear polyethyleneimine, branched polyethyleneimine, zwitterionic, or amphoteric functional groups or any combination thereof.

11. A method of producing a cartridge comprising:
providing a mat comprising a woven or non-woven polymer;
stacking at least two disks punched from the mat or winding the mat around an inert core to produce a spiral configuration;
optionally pressing the at least two disks together; and
applying an epoxy to an outer diameter of the stacked disks or an outer layer of the spiral configuration, wherein the epoxy cures to form a waterproof seal around the outer diameter of the stacked disks or forms a waterproof seal around the outermost layer of the spiral configuration.

12. The method of claim 11, wherein stacking comprises stacking from at least 2 to 1000 disks, or wherein the winding comprises producing a spiral configuration comprising from 1 to 1000 layers.

13. The method of claim 11, wherein the at least two disks are pressed together under pressure, wherein the pressure used for forming the stack is from 0 to 60 PSI.

14. The method of claim 11, wherein the epoxy comprises Novolac 630, Novolac 633, vinyl ester 663 epoxies, or any combination thereof.

15. The method of claim 11, wherein the woven or non-woven polymer comprises polysulfones, polyamides, polyimides, polyamideimides, polyaramids, polyesters, polycarbonates, polyethylene, polypropylene, or any combination thereof.

16. The method of claim 11, wherein the disks have a diameter of from 0.5 inches to about 300 inches or wherein the woven or non-woven polymer layered around an inert central core has from 1 to 1000 layers in the spiral configuration.

17. The method of claim 11, wherein the method further comprises a treatment step wherein the cartridge is treated with a solution to functionalize the woven or non-woven polymer, wherein the treatment step comprises:
heating the solution to a temperature appropriate for the treatment of the cartridge;
pouring or flowing the heated solution into the cartridge to functionalize the woven or non-woven polymer for a selected surface chemistry.

18. The method of claim 17, wherein the selected surface chemistry comprises at least one functional group, wherein the functional group is carboxylic, aminophosphonic, aminophosphinic, phosphonic, phosphinic, iminodiacetic, sulfonic, bis-picolylamine, quaternary ammonium, phosphorylcholines, sulfobetaines, carboxybetaines, linear polypropyleneimine, branched polypropyleneimine, linear polyethyleneimine, branched polyethyleneimine, zwitterionic, or amphoteric functional groups or any combination thereof.

19. A method of generating a column of a modified porous substrate material comprising:
equilibrating a chromatographic column and at least one cartridge to a temperature;
installing the cartridge of claim 11 into the chromatographic column;
filling the chromatographic column with a fluid, a priming solution, or a buffer; and
enclosing the chromatographic column, wherein the chromatographic column has a flow rate of from 0.01 m³/hour to 1000 m³/hour.

20. The method of claim 19, wherein the buffer is citric acid, lactic acid, acetic acid, 2-(N-Morpholino) ethanesulfonic acid (MES), N-(2-Acetamido)-2-iminodiacetic acid (ADA), 3-(N-Morpholino) propanesulfonic acid (MOPS), N-(2-Hydroxyethyl) piperazine-N′-(2-ethanesulfonic acid) (HEPES), phosphate, bicine, N-Methylpiperazine, Piperazine, L-Histadine, bis-Tris, bis-tris propane, triethanolamine, Tris, N-Methyldiethanolamine, Diethanolamine, 1,3-Diaminopropane, Ethanolamine, Piperazine, and piperdine, imidazole, N-ethylmorpholine, triethanolamine, 2-amino-2-methyl-1,3-propanediol, 2-amino-2-methyl-1-propanol, or any combination thereof.
